(19) United States
(12) Patent Application Publication
(10) Pub. No.: US 2015/0116311 A1
(43) Pub. Date: Apr. 30, 2015

(54) ACCELERATED VIDEO POST PROCESSING SYSTEMS AND METHODS

(71) Applicant: QUALCOMM Incorporated, San Diego, CA (US)

(72) Inventor: Michael Leung, Toronto (CA)

(73) Assignee: QUALCOMM Incorporated, San Diego, CA (US)

(21) Appl. No.: 14/065,350

(22) Filed: Oct. 28, 2013

(51) Int. Cl. G06T 1/20; G06T 1/60; G06T 15/00

(52) U.S. Cl. CPC G06T 1/20; G06T 15/00; G06T 1/60
USPC 345/419; 345/520

(57) ABSTRACT

A method for performing video processing on a mobile device includes receiving at least one video processing task that is intended for a graphic processing unit (GPU); determining whether a display controller with direct memory access can perform the at least one video processing task; and assigning the at least one video processing task to the display controller to perform the at least one video processing task in response to determining that the display controller can perform the at least one video processing task.

### BACKGROUND

1. Field

The disclosure relates generally to the field of video post processing. In particular, this disclosure relates to systems and methods for offloading certain video post processing tasks intended for a graphic unit processor (GPU) to a display controller in mobile devices.

2. Background

Mobile devices are capable of performing video processing tasks and the demand for video processing continues to increase. With the proliferation of LTE and 4G data transfer rates, video streaming (with HD quality videos) on mobile devices (e.g. cell phones, smartphones, tablets, laptops, convertible tablets) has become routine. Video processing performed by a 3D engine of a graphics processing unit (GPU) consumes a significant amount of power and memory. Mobile devices have a limited amount of battery power, but consumers continue to demand longer battery lives from their mobile device while performing video intensive tasks. In particular, growth of real-time entertainment, such as videos, will continue to grow at an exponential rate in the coming years.

Post processing of video content on a mobile device may be performed by a 3D engine, such as a graphics processing unit (GPU). Depending on the type of post processing, video post processing by the GPU can be resource intensive and inefficient (e.g., consume too much power or use too much memory on a mobile device). Increasing opportunities to deactivate the GPU can increase battery duration of a mobile device.

Computer systems may use a plurality of GPUs, for example, a discrete graphics processing unit (dGPU) or an integrated graphics processing unit (iGPU). The iGPU may use less power compared to the dGPU. The dGPU may have better processing performance compared to the iGPU. Systems are capable of managing workload between the two types of GPUs. For example, systems may use an iGPU for certain tasks or applications and the dGPU may be used for other tasks or applications. In other examples, the dGPU may offload certain video processing tasks to the iGPU.

However, both GPUs perform similar functions, such as, they both retrieve video data from memory (e.g. graphic memory or integrated memory (RAM)) and output the processed information to the memory to be output to display hardware. That is both types of GPUs may not perform processing and output in real time. Both types of GPUs consume a significant amount of memory and power on a mobile device. In general, the level of programmability of any hardware may determine the power usage of the hardware. In particular, GPUs usage may perform a memory-to-memory transfers and at a later time the GPU generated data is displayed using display hardware.

### SUMMARY

A method for performing video processing on a mobile device includes, but is not limited to any one or combination of, (i) receiving at least one video processing task that is intended for a graphic processing unit (GPU); (ii) determining whether a display controller with direct memory access can perform the at least one video processing task; and (iii) assigning the at least one video processing task to the display controller to perform the at least one video processing task in response to determining that the display controller can perform the at least one video processing task.

A system for performing video processing on a mobile device includes a graphic processing unit (GPU), a display controller, and a task controller. The display controller has direct memory access. The display controller is configured to perform at least one video process task intended for the GPU. The task controller is configured to determine whether the display controller can perform the at least one video processing task. The task controller is configured to assign the at least one video processing task to the display controller in response to determining that the display controller can perform the at least one video processing task.

In various embodiments, the method further includes processing, by the display controller, video by performing the at least one video processing task; and

outputting, by the display controller, the processed video directly to a display device without storing the result of the video processing in a memory.

In various embodiments, the method further includes processing, by the GPU, video by performing the at least one video processing task in response to determining that the display controller cannot perform the at least one video processing task.

In some embodiments, the method further includes storing, by the GPU, a result of processing the video in a graphic memory while performing the at least one video processing task; and outputting, from the memory, the result to a display device.

In various embodiments, the determining comprises determining whether the display controller is capable of performing the at least one video processing task.

In various embodiments, the determining comprises determining whether the display controller performs the at least one video processing task faster than the GPU would performing the at least one video processing task.

In various embodiments, the determining comprises determining whether the display controller performs the at least one video processing task using less power than the GPU would performing the at least one video processing task.

In various embodiments, the determining comprises determining whether the display controller has a processing bandwidth to perform the at least one video processing task within a predetermined time period.

In various embodiments, the determining comprises determining whether the display controller is available to perform the at least one video processing task.

In various embodiments, the determining comprises determining whether the at least one video processing task is one of a first processing task type or a second processing task type. The display controller can perform the at least one video processing task if the at least one processing task is of the first processing task type. The display controller cannot perform the at least one video processing task if the at least one processing task is of the second processing task type.

In various embodiments, the at least one video processing task is at least one of blending, scaling, de-interlacing, color conversion of video.

In various embodiments, the GPU is distinct from the display controller.

In various embodiments, GPU and the display controller are integrated on a system on chip.

In various embodiments, the display controller further comprises a video processing module that outputs a video data stream that is sent to a layer mixer determination module; a primary display module that outputs a video data stream that is sent to the layer mixer determination module; and a secondary display module that outputs a video data stream that is sent to the layer mixer determination module. The layer determination module is configured to select at least one layer mixer from a plurality of layer mixers to perform blending for the at least one of the video processing module, the primary display module, and the secondary display module.

In various embodiments, the GPU comprises a 3D engine. The display controller comprises a 2D engine.

In various embodiments, the display controller is configured to use direct memory access (DMA) to process at least one video processing task in real time and output the result to the display device.

An apparatus for performing video processing on a mobile device includes, but is not limited to, means for receiving at least one video processing task that is intended for a graphic processing unit (GPU); means for determining whether a display controller with direct memory access can perform the at least one video processing task; and means for assigning the at least one video processing task to the display controller to perform the at least one video processing task in response to determining that the display controller can perform the at least one video processing task.

A method of performing post processing of video content on a mobile device having a mobile station modem comprising a graphics processing unit (GPU) and a display includes, but is not limited to any one or combination of, determining whether a type of a video post processing task is a first type or a second type; performing the video post processing task on the display controller processor if the task is determined to be the first type; and performing the video post processing task on the GPU if the task is determined to be the second type.

### BRIEF DESCRIPTION OF THE SEVERAL VIEWS OF THE DRAWINGS

FIG. 1 illustrates a mobile device graphics system according to various embodiments of the disclosure.

FIG. 2 is a portion of the mobile device graphics system from FIG. 1.

FIG. 3 is a diagram illustrating a display controller schematic according to various embodiments of the disclosure.

FIG. 4 is a diagram illustrating a display controller schematic according to various embodiments of the disclosure.

FIG. 5 is a flowchart of a method of accelerating video post processing according to various embodiments of the disclosure.

FIG. 6A is a flowchart of a method of accelerating video post processing according to various embodiments of the disclosure.

FIG. 6B is a flowchart of a method of accelerating video post processing according to various embodiments of the disclosure.

FIG. 7 is a diagram of an apparatus for accelerating video post processing according to various embodiments of the disclosure.

### DETAILED DESCRIPTION

Various embodiments relate to offloading certain video post processing tasks of a mobile processor or the like from a GPU (a 3D engine) to a display controller (also referred to as a hardware processor or a display hardware subsystem), which is designed for a 2D composition type of operation (a 2D engine). For instance, in a mobile processor, the display controller may be configured to perform certain video post processing tasks (e.g., blending, scaling, de-interlacing, color conversion, etc.) that would otherwise be performed by the GPU.

A task controller may determine whether a video post processing task should be offloaded from the GPU to the display controller. This determination may be based on the type of task, load on one or more of the GPUs and the display controller, and/or other factors. For example, blending, scaling, de-interlacing, color conversion may be generally performed by the display controller while other types can only be performed by the GPU (e.g., if blending two items, then display controller should perform task; if blending five items, then GPU should perform task). Accordingly, based on the determination, the task may be offloaded to the display controller for processing thereof. While the display controller is performing the task, the GPU may be deactivated to conserve device resources. In other embodiments, the display controller may perform the video processing tasks that were intended for the GPU, for instance, when the display controller is capable of performing the task, the display controller can perform the task faster than the GPU, and/or the like

In some embodiments, the task is completely offloaded from the GPU to the display controller (i.e., 100% is performed by the display controller). In other embodiments, a portion of the task is offloaded from the GPU to the display controller (i.e., 1-99% is performed by the display controller).

In further embodiments, offloading GPU operations on the display hardware also allows for performing multi-pass operations (i.e., achieving a result by repeating operations on the same data until the desired result is achieved). In particular, the display hardware can be adjusted during each pass to achieve the desired effect. One example is a feature called constriction, where the desire is to reduce or obscure the quality of the video. Performing a multi-pass operation on the display controller to downscale then upscale the data can be used to achieve this result. Downscaling reduces the quality of the video and upscaling restores the original size of the video.

Various embodiments allow for a simplified programming model, which can reduce the number of CPU instructions needed to perform an operation. The GPU is flexible, but needs a lot of configuration to achieve the desired result. Performing video processing on the display controller can simplify this operation because the display controller is designed for 2D composition type operations and the programming model is much less involved. For example, programming rectangle information is much easier on the display controller because the display controller is designed for simple 2D rectangular coordinates instead of coordinates in three dimensions. In various embodiments, the display controller may use resistor-transistor logic (RTL) which is quicker and simpler to program than a GPU. Resistor-transistor logic is a type of digital circuits that uses resistors as the input network and bipolar junction transistors as switching devices. One advantage of the RTL technology is that it uses a minimum number of transistors. Instead, the GPU uses complex shaders to perform the same type of operations. In various embodiments, a complex shader may be a GPU shader program or circuit that has a plurality of instructions that may be executed on a set of pixel data. In other embodiments, the GPU shader may be a program that executes multiple complex arithmetic operations on a small set of data. Moreover, the CPU uses complex floating point algorithms to perform these types of operations.

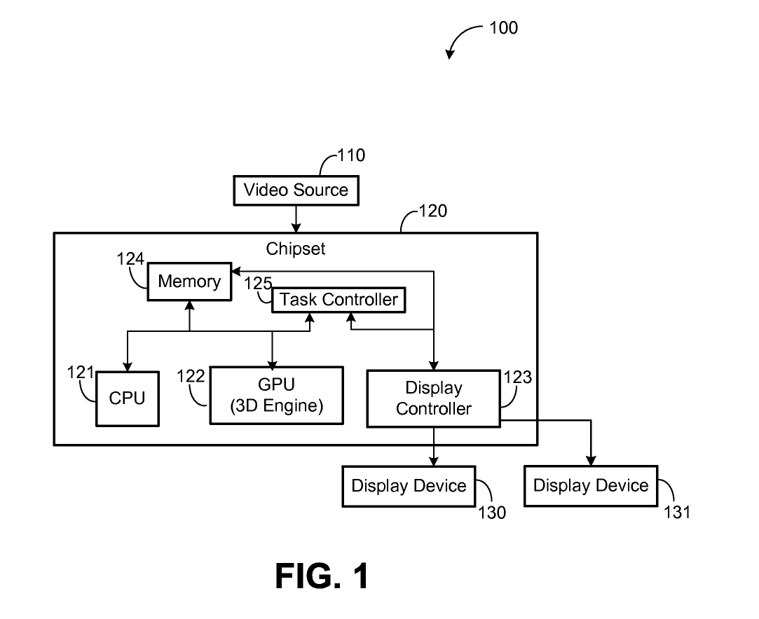

FIG. 1 illustrates a mobile device graphics system 100 according to various embodiments of the disclosure. In some embodiments, the system 100 may be part of a mobile device. The mobile device may be configured to receive various types of data streams including video data streams. In other embodiments the mobile device may store a plurality of videos which may be processed on the system 100 upon the execution of video software. The system 100 illustrates a portion of a mobile device circuitry; the mobile device may be a cell phone, smart phone, tablet, laptop and the like. The system 100 includes (but is not limited to) chipset 120 and a first display device 130. In some embodiments, the system 100 may further include a second display device 131. Video source 110 may be information that is received from a source that is external to the system 100. In some embodiments, the video source 110 may be video content data that must be processed in order for it to be displayed. In other embodiments, the video source 110 data may be generated by the chipset 120.

The chipset 120 includes a plurality of circuits, such as but not limited to, a central processing unit 121 (CPU), graphic processing unit 122 (GPU), display controller 123, memory 124, and task controller 125. In various embodiments, the chipset 120 may include a plurality of other circuits. The CPU 121 is connected to various circuits within the chipset 120. For example, the CPU 121 may access the memory 124 or other circuits in chipset 120. The CPU 121 may perform the arithmetical, logical, and input/output operations of the system 100. The CPU 121 may receive data from the memory 124 and may send the processed information back to the memory 124.

The GPU 122 may manipulate and alter data in the memory 124 to accelerate the creation of images in a frame buffer intended for output to a display (e.g., the first display 130 and/or the second display 131). In some embodiments, the GPU 122 may access the memory 124 for video processing or post video processing tasks. After performing one or more post processing tasks, the GPU 122 may store information in the memory 124 and the processed information from the GPU 122 may be stored back to the memory 124. In other embodiments, the GPU 122 may send the processed information to the display controller 123. The GPU 122 may be connected to a graphics memory or an on-chip memory that is used by the GPU 122 to access video processing tasks and to store the results of the video processing tasks.

The display controller 123 may include (but is not limited to) a digital-to-analog conversion circuit, a pixel processing circuit, and a timing engine to timely manipulate the pixels on the first display device 130. In various embodiments, the display controller 123 is configured to perform various video post processing tasks. In some embodiments, the video post processing tasks may be offloaded from the GPU 122 to the display controller 123. In some embodiments, offloading the post processing tasks to the display controller 123 may allow the system 100 to conserve power and/or render the pixels faster than using the GPU 122. The display controller 123 may include specialized hardware that is capable of performing video processing tasks in real time and output the results directly to the first display device 130 and/or the second display device 131. The display controller 123 may be a capable of accessing the memory 124 by performing direct memory access (DMA) to receive various video post processing tasks. The display controller 123 is capable of outputting one or more video signals to a plurality of display devices (e.g., the first display 130 and/or the second display 131). The display controller 123 may receive instructions from the task controller 125 to perform video processing tasks that may have been intended for the GPU 122.

In various embodiments, the system 100 may realize various advantages by using the chipset 120 with the display controller 123. As mentioned above, the display controller 123 may be less programmable than the GPU 122 or the CPU 121. The lack of programmability makes the display controller 123 more secure compared to a highly programmable GPU or CPU. In particular, the programmability of the GPU 122 or the CPU 121 allows those cores to possibly access secure areas of memory (e.g., 124). For content protection reasons the display controller 123 may be selected to perform certain tasks. The video post processing tasks that involve HDMI (High-Definition Multimedia Interface) and HDCP (High-bandwidth Digital Content Protection) may be considered protected when the data is passed through the display controller 123 of the chipset 120. The display controller 120 may send data to a display (e.g., display device 130 and/or 131) or to memory (e.g., 124) and the information is considered secure because the caller cannot freely manipulate the data as it is being post-processed by the display controller 123. The specialized nature of the chipset 120 and the display controller 123 ensures that a rogue task controller/device driver is unable to gain access to the memory 124 by simply changing the programming of the hardware.

The task controller 125 may contain logic circuitry that determines which of the plurality of video processing tasks may be assigned to the GPU 122 or assigned to the display controller 123. The task controller 125 may be configured to determine whether the display controller 123 is capable of performing a video processing task. In some embodiments, the task controller 125 may determine an amount of power that would be used by the GPU 122 for performing a video processing task as compared to an amount of power that would be used by the display controller 123 for performing the video processing task. Thus, in some embodiments, to optimize power consumption and preserve battery life, the task controller 125 may assign the video processing task to the component that would use the least amount of power. The display controller 123 may use less power than a GPU 122 for certain video processing tasks. Accordingly, the task controller 125 may assign such video processing tasks to the display controller 123.

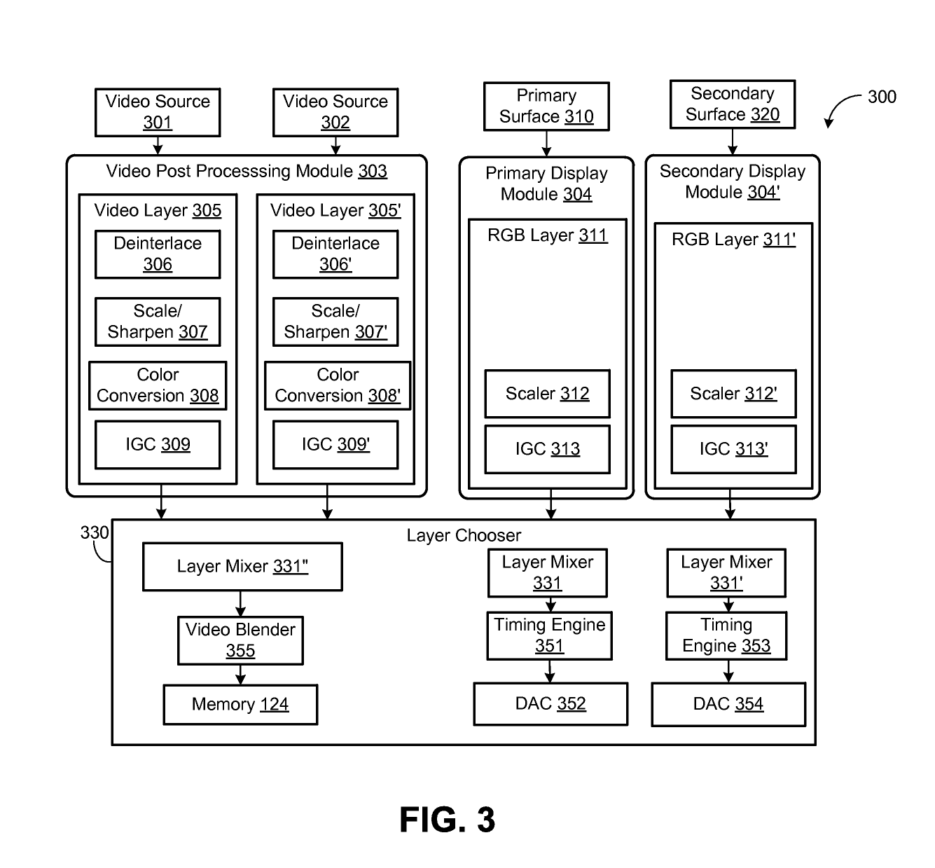

In various embodiments, the task controller 125 may determine whether the display controller 123 is capable of performing the video processing task, for instance, within a predetermined time period. Accordingly, upon determining that the display controller 123 is capable of performing the video processing task, the task controller 125 may assign the video processing task to the display controller 123 because the display controller 123 can perform the task within the predetermined time period. In various embodiments, the task controller 125 may also be able to reconfigure portions of the display controller 123 (e.g., refer to FIG. 3). In particular, the task controller 125 may determine which layer mixer from the display controller 123 to use for a given task.

In various embodiments, the task controller 125 may determine whether the GPU 122 or the display controller 123 will perform the video processing task based on (but not limited to) one of or more of the type of task, hardware capability of each component, timing of the task, processing load on each component, power usage by each component, availability of each component, and/or the like. In some embodiments, when the task controller 125 assigns the task intended for the GPU 122 to the display controller 123, the task controller 125 (or other component) may shut down the GPU 122 in order to conserve power in the system 100. In particular embodiments, the GPU 122 may be turned on by the task controller 125 when the task controller 125 determines the display controller 123 is not available to perform a selected task (e.g., the display controller 123 is busy, the display controller 123 is not capable of performing the selected task, etc.).

An example list of video processing tasks is provided below in table 1.

TABLE 1

| | Display Controller |
|---|---|
| Features | 2 Video Pipes |
| Tiled Input Format | Yes |
| Output Formats (RGB) | RGB888, RGB888, |
| | RGB565 |
| Output Formats (YUV) | YUV 420 (NV12), |
| | YUV 422 (YUV 2) |
| | (h2v1 interleaved) |
| DeinterlaceTechnology | Field Adaptive |
| YUV2RGB | Yes |
| Stretch X | Yes (20x) |
| Stretch Y | Yes (20x) |
| Alpha Blend | Yes |
| Sub Rects | Yes |
| (Source cropping) | |
| SubStreams | Yes |
| (Composing video + substreams) | (1 sub-stream) |
| SubStreamsExtended | Yes |
| (Color convert + deinterlace + | |
| blending) | |
| YUV2RGBExtended | Yes |
| (YUV2RGB + deinterlace + blend) | |
| AlphaBlendExtended | No |
| (alpha blend with dest) | |
| Constriction | Yes(¼x) |
| NoiseFilter | Yes |
| DetailFilter | Yes |
| LinearScaling | No |
| (In linear gamma space) | |
| MaintainsOriginalFieldData | Yes |
| Aspect ratio change | Yes |
| Range Mapping | Yes |
| De-ringing | No |
| RGB and YUV Mixing | Yes |
| Deinterlacing Multiple Streams | Yes |
| RGB Background Colors | Yes |
| Luma Keying | No |
| Dynamic switching of Interlaced | No |
| Formats | |
| Inverse telecine | No |
| Frame-rate conversion | No |
| Alpha-fill modes | No |
| Noise reduction and edge | Yes |
| enhancement | |
| Anamorphic non-linear scaling | No |
| Extended YCbCr | No |

As shown above in Table 1, the display controller 123 is not capable of performing certain video processing tasks. For example, in particular embodiments, the display controller 123 may not have the hardware to perform frame rate conversion. Accordingly, in such embodiments, frame rate conversion will not be assigned to the display controller 123. However, in some embodiments, a display controller 123 that includes the hardware to perform frame rate conversions may be assigned the task to perform frame rate conversion by the task controller 125.

After the display controller 123 performs the video processing tasks, resulting pixel information is sent to a first display device 130 and/or second display device 131. In some embodiments, first display device 130 may be a primary display and second display device 131 may be a secondary display.

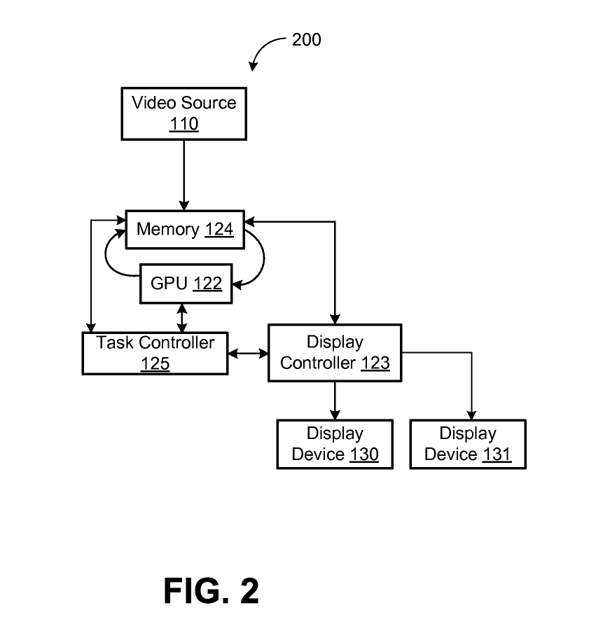

FIG. 2 is a portion 200 of the mobile device graphics system from FIG. 1. In particular, FIG. 2 shows the video source 110, the GPU 122, the display controller 123, the memory 124, the task controller 125, the first display device 130, and the second display device 131. As shown in FIG. 2, the GPU 122 is configured to receive video source data via the memory 124. The GPU 122 is configured to perform video processing tasks and store the results from the processing back in memory 124. After storing the results in the memory 124, the display controller 123 may send the data that was processed by the GPU 122 to the first display device 130 and/or second display device 131. In other embodiments, the display controller 123 is configured to access the memory 124 without the GPU 122 having processed the video source data. In such embodiments, the display controller 123 performs the video processing tasks and sends the display data to the first display device 130 and/or the second display device 131 in a real-time (without storing the information back into the memory 124) manner. As discussed, the task controller 125 determines which component (the GPU 122 or the display controller 123) will perform a video processing task. In various embodiments, the task controller 125 may access the memory 124 to determine which tasks are going to be performed or analyze the history of the most recently performed tasks to predict the next operations. In other embodiments, the task controller 125 may be configured to scan or prefetch from the memory 124 in order to determine the next video processing task to be performed. Accordingly, in some embodiments, when the GPU 122 and/or the display controller 123 are performing one or more tasks, the task controller 125 may be reading the memory 124, determining which component will perform the video processing task, and storing the instructions with respect to the determination back into the memory 124. In some embodiments, the task controller 125 may not communicate directly with the GPU 122 and/or the display controller 123. Instead, since both the GPU 122 and the display controller 123 are capable of accessing the memory 124, the task controller 125 may communicate directly with the memory 124.

FIG. 3 is a diagram illustrating a display controller schematic 300 according to various embodiments of the disclosure. The display controller schematic may, for example, correspond to the display controller (e.g., 123 in FIGS. 1-2). With reference to FIGS. 1-3, the display controller schematic 300 includes a plurality of modules, layers, and/or mixers. The display controller schematic 300 illustrates various layers that are capable of performing video post processing tasks and RGB rendering tasks. The display controller schematic 300 illustrates that the video post processing module may use the layer mixers from the RGB layers and the RGB layers may use the mixer that is usually assigned to the video post processing module.

The display controller schematic 300 illustrates receiving data from a video source 301 (e.g., the video source 110), video source 302 (e.g., the video source 110), primary surface 310, and secondary surface 320. A video post processing module 303 is configured to receive the data from the video source 301 and the video source 302. The primary display module 304 may be configured to receive data from the primary surface 310 and the secondary display module 304′ may be configured to receive data from the secondary surface 320.

The video post processing module 303 includes one or more video layers. For example, the video post processing module 303 may include a video layer 305 and a video layer 305′. The video layers 305 and 305′ may respectively include (but is not limited to) a de-interlace 306 and 306′, scale/sharpen 307 and 307′, color conversion 308 and 308′, and inverse gamma correction (IGC) 309 and 309′ module. Each of the above modules is configured to perform various functions, for example, the de-interlace modules 306 and 306′ are configured to deinterlace the received video images. The scale/sharpen modules 307 and 307′ are configured to scale or sharpen the video images. The color conversion modules 308 and 308′ are configured to perform color conversion on the video images. The ICG modules 309 and 309′ are configured to perform inverse gamma color correction (IGC) on the video images. After performing the above functions the video layers 305 and 305′ may each output a video data stream to a layer chooser 330.

The primary display module 304 and 304′ include a RGB layer 311 and a RGB Layer 311′, respectively. In particular embodiments, each RGB layer includes (but is not limited to) a scaler and an inverse gamma correction module. RGB layer 311 includes a scaler 312 and an IGC 313. RGB layer 311 includes a scaler 312′ and an inverse gamma correction module 313′. Each RGB layer 311 and 311′ outputs an image stream to the layer chooser 330.

The layer chooser 330 includes a plurality of layers and other components. In some embodiments the layer chooser 330 may receive information from the task controller 125 to determine which layer to choose. In other embodiments, the layer chooser 330 may determine which layer to choose based on the present workload of each layer. In particular embodiments, the layer chooser 330 includes (but is not limited to) a layer mixer 331, a layer mixer 331′, and a layer mixer 331″. The layer mixer 331, 311′, and 311″ are configured to receive image data and perform blending.

In various embodiments, the layer chooser 330 may send the output from RGB layer 311 to layer mixer 311″ based on a determination that their mixer 331 is overloaded or is incapable of processing the output. In other embodiments, the layer chooser 330 may assign layer 331, 331′, 331 to receive the output from any one of the video layer 305, video layer 305′, RGB layer 311 and RGB layer 311′. The layer chooser 330 may assign any layer mixer to perform the processing for any layer.

The output from layer mixer 331 is sent to a timing engine 351. Timing engine 351 is configured to determine the timing of the pixels and then send the pixel data to a DAC 352. The DAC 352 may convert the digital data into analog data to be sent to the display devices 130 or 131. The output from layer mixer 331′ may be received by timing engine 353 that is configured to determine the timing of the pixels and send the pixel data to a DAC 354. The DAC 352 may convert the digital data into analog data to be sent to the display devices 130 or 131. The output from the layer mixer 331″ may be sent to a video blender module 355. The video blender module 355 is configured to perform video blending of the data received from the layer mixer 331″. After performing the video blending the results are stored in the memory 124. In other embodiments, the results from the video blending may be sent to a display device (e.g., the first display device 130 and/or the second display device 131).

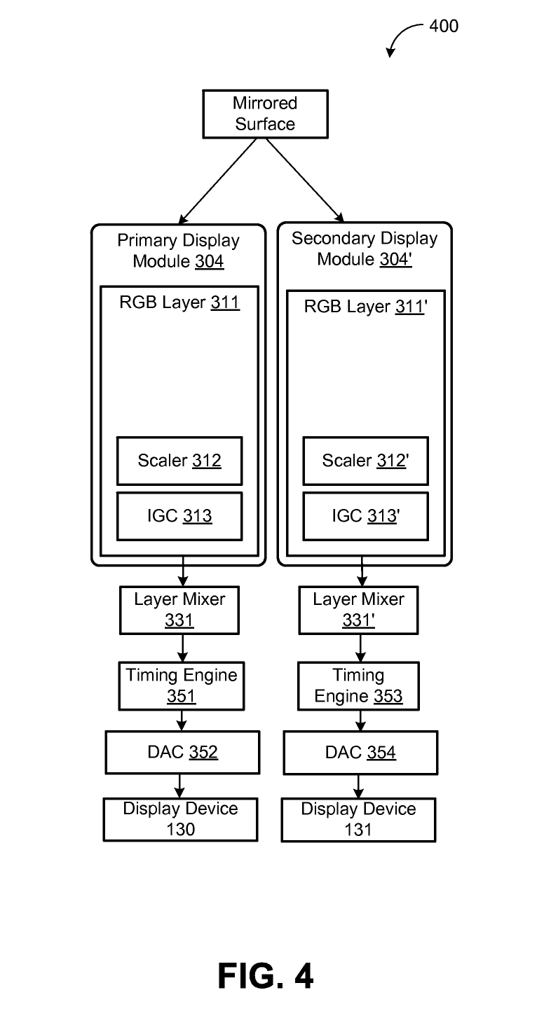

FIG. 4 is a diagram illustrating a device controller schematic 400 according to various embodiments of the disclosure. The display controller schematic may, for example, correspond to the display controller (e.g., 123 in FIGS. 1-2). The device controller schematic 400 illustrates a scenario in which a user implements a mirrored surface display. In particular, the user implements the first display device 130 and the second display device 131 to display the same image from a single video source. Accordingly, the DAC 352 and the DAC 354 may convert the same digital data into analog data. The primary display module 304 and the secondary display module 304′ include the same layers as discussed above with respect to FIG. 3. However, in this embodiment, the output from RGB layer 311 is sent directly to layer mixer 331. In this embodiment, the output from RGB layer 311′ is sent directly to layer mixer 331′. In some embodiment, the layer chooser 330 discussed above in FIG. 3 may choose to retain this configuration for a mirrored surface display scenario. The output from the layer mixer 331 is received by the timing engine 351. The output from the layer mixer 331′ is received by the timing engine 353. After the timing engines 351 and 353 determine the pixel timing the output is sent to be displayed on display devices 130 and 131, respectively. In various embodiments, the timing engines 351 and 353 may output digital data to the DAC 352 and the DAC 354, respectively. The DACs 352 and 354 may output an analog signal to the display devices 130 and 131, respectively.

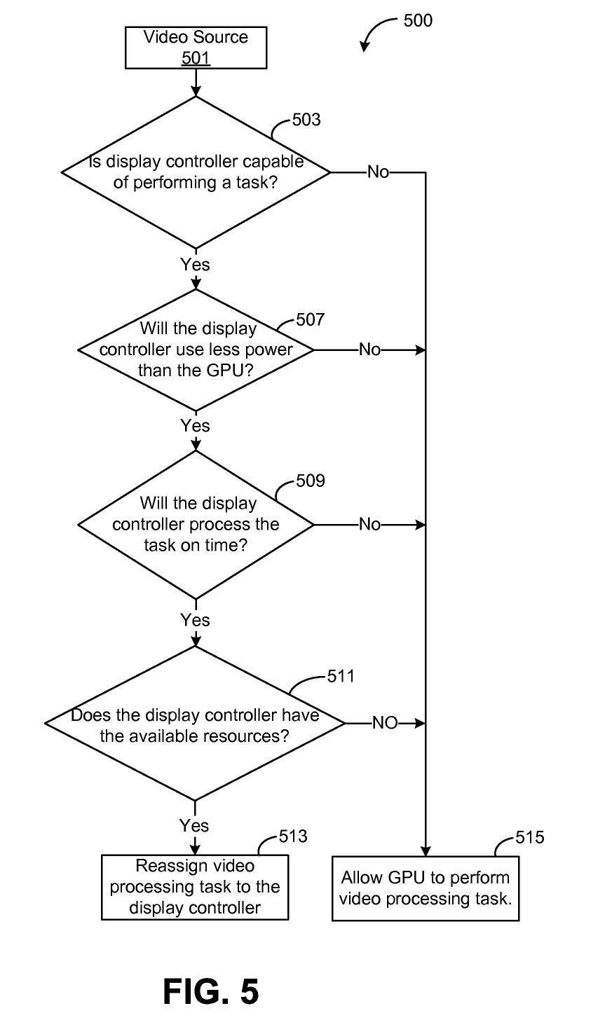

FIG. 5 is a flowchart of a process 500 of accelerating video post processing according to various embodiments of the disclosure. With reference to FIGS. 1-5, in various embodiments, the process 500 may be performed by the task controller 125. In particular, the process 500 may be used by the task controller 125 to determine which of the video processing components (GPU 122 or display controller 123) perform the video processing task. In general, the display controller 123 tends to use less power than the GPU 122 and tends to perform tasks in real time as they are output to the display device 130 and/or 131. However, at times, the display controller 123 may have a high workload and may be unable to timely perform the video processing tasks. The process 500 includes receiving a video source data (e.g., 110, 301, etc.) at 501. At decision block 503, the task controller 125 may determine whether the display controller 123 is capable of performing a video post processing task. If the display controller is not capable of performing the video post processing task (block 503: No), then the video processing task may be performed by the GPU 122 at block 515. The capability of display controller 123 to perform a video processing task is determined, for example, by the type of task and by the hardware of the display controller 123. For example as shown in Table 1, the display controller 123 may not have the appropriate hardware to perform all video processing tasks. In other embodiments, the task controller 125 may access a predetermined list of capabilities for the chipset 120 to determine which video-post processing tasks can be processed by the display controller 123 of the chipset 120. In various embodiments, the GPU 122 and the display controller 123 combination is used to determine the tasks that the display controller 123 is capable of performing. The list of tasks may be stored in the predetermined list of capabilities. If at decision block 503 the display controller 123 is capable of performing the task (block 503: Yes), then the process 500 goes to decision block 507.

At decision block 507, the task controller 125 determines whether the display controller 123 will use less power than the GPU 122 to perform the task. The power needed for a task can be determined based on dynamic calculations and static information. The processing power and bandwidth required to process a data stream can be dynamically calculated. For example, to process a 1080p 60 fps video stream in YUV space can be calculated as following equations.

Number of pixels (columns)×Number of pixels (rows)×frames per second=pixels per second of pixel processing. Equation (1):

Example: 1920×1080×60=124.4 Mpixels/second (124.4 million pixels per second of pixel processing)

Number of pixels (columns)×Number of pixels (rows)×bytes per pixel×read and write operations (memory to memory)×frames per second=pixels per second of pixel processing. Equation (2):

Example 1920×1080×1.5×2×60=373.2 MB/second (373.2 megabytes per second of read/write bandwidth)

Based on the performance requirements, a static table may provide the amount of power the GPU 122 may use to achieve the above performance requirements compared to the power used by the display controller 123 and the chipset 120 to achieve the same performance requirements. The comparison may yield the result for block 507.

Upon determining that the display controller 123 will use less power than the GPU 122 to perform the task (block 507: Yes), the process 500 proceeds to decision block 509. However, if the GPU 122 will perform the task by using less power than the display controller 123 (block 507: No), the process 500 allows the GPU 122 to perform the video processing task at block 515.

At decision block 509, the process 500 determines whether the display controller 123 will be able to perform the task in a timely manner based on a time constraint provided by the task. Each task in the video processing should be performed in a timely manner (which may be different for any given task); otherwise the video display will not generate the desired output. Accordingly if the display controller 123 cannot perform the task within the desired time (block 509: No), then the process 500 allows the GPU 122 to perform the video processing task at block 515. Upon determining that the display controller 123 can process the task within the desired time (block 509: Yes), then the process 500 proceeds to decision block 511. The current workload of the display controller 123 and the GPU 122 can be used to determine whether the display controller 123 or the GPU 122 can process the additional workload. The efficiency and throughput of the display controller 123 and the GPU 122 is known, or at least can be determined offline empirically and stored in a table. For example, a GPU may have an efficiency of 0.85 pixels per clock cycle with a maximum clock speed of 500 Mhz. The example GPU has a theoretical maximum of 425 MPix/sec of raw processing power. If the task controller is aware of the current loads on the GPU, the processing needed for the additional load can be used to estimate if the tasks can be performed on time. For example, the GPU is current under a load of 400 MPix/sec, and the user wants to display a 1080p60 stream, which is a new load of 124.4 Mpix/sec. Based on a 425 MPix maximum load the task controller will be able to determine that the proposed load exceeds the maximum load and therefore the GPU can only process the 1080p stream in at a lower frame rate as shown below:

1920*1080*frame_rate=25 Mpix (remaining processing power)

Frame_rate=25 MPix/(1920*1080)

Frame_rate=12 fps.

Accordingly, instead of a 60 hz stream the device could only render a 12 fps stream with the available processing on GPU. A similar calculation can be performed for the display controller 123, but with different theoretical maximums and efficiencies.

At decision block 511 the task controller 125 determines whether the display controller 123 has the available resources (or is otherwise available) to perform the video processing task. Upon determining that the display controller 123 has resources to perform the video processing task (block 511: Yes), the task controller 125 may assign the video processing task to the display controller 123 at block 513. Upon determining that the display controller 123 does not have the resources to perform the video processing task (block 511: No), the process 500 allows the GPU 122 to perform the video processing task at block 515. To determine the available resources of the display controller 123 the task controller 125 may compare the number of layers that are available with the number of layers that are currently being used or are scheduled to be used. For example, the display controller 123 may have 3 layers (Layer 1, Layer 2, Layer 3). In this example, if two layers are being used to display the user interface and video playback (real-time video playback), the task controller 125 can determine that there is only 1 layer for video post-processing. Accordingly, background video post processing may be performed using the remaining layer. Depending on the workload on the display controller 123, there may have 1, 2, 3 or more layers available for video post processing.

It should be noted that in other embodiments, the blocks (e.g., 503, 507, 509, 511) may be performed in any other hardware. In other embodiments, some blocks may be omitted and/or other blocks (e.g., determinations) may be included.

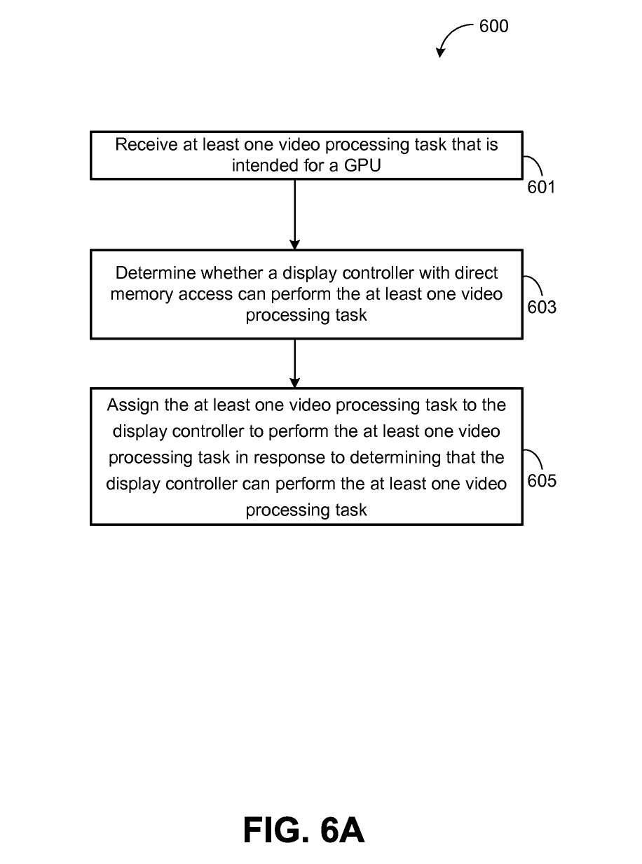

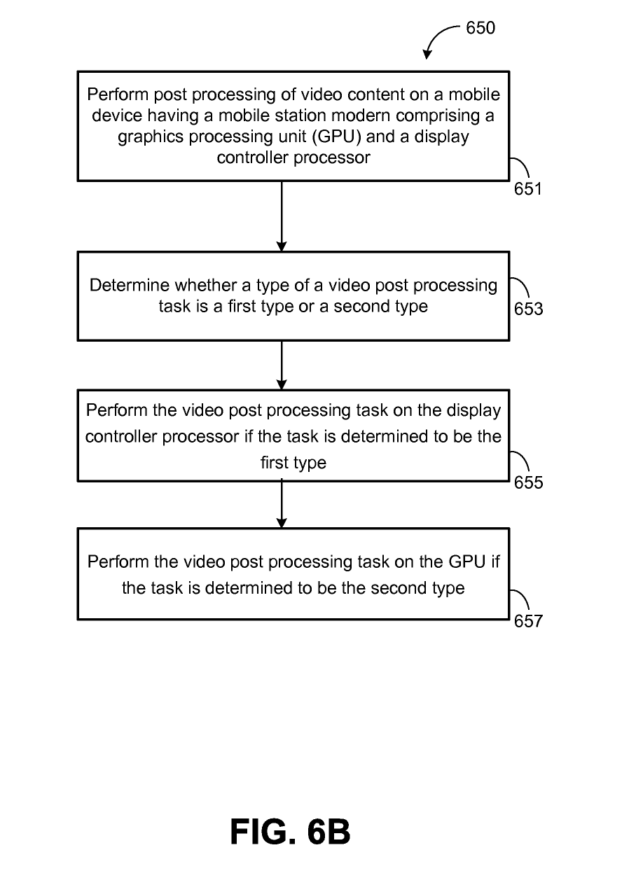

FIG. 6A is a flowchart of a method 600 for accelerating video post processing according to various embodiments of the disclosure. The method 600 includes (but is not limited to) blocks 601, 603, and 605. With reference to FIGS. 1-6A, at block 601, the mobile device chipset 120 may receive at least one video processing task that is intended for the GPU 122. Next at block 603, the task controller 125 may determine whether the display controller 123 with direct memory access can perform the at least one video processing task. Next at block 605, the at least one video processing task may be assigned to the display controller 123 to perform the task after determining that the display controller 123 can perform the at least one video processing task.

Various advantages may be realized by performing the above process. For example, the display controller 123 may be able to perform the at least one video processing task faster than the GPU 122 and/or by using less power than the GPU 122. After assigning the at least one video processing task, the task controller 125 may turn off or keep idle the GPU 122 to conserve power. Moreover, the display controller 123 is configured to access the memory 124 and generate an output to the display devices 130 and/or 131 in real time without storing any information back to the memory 124.

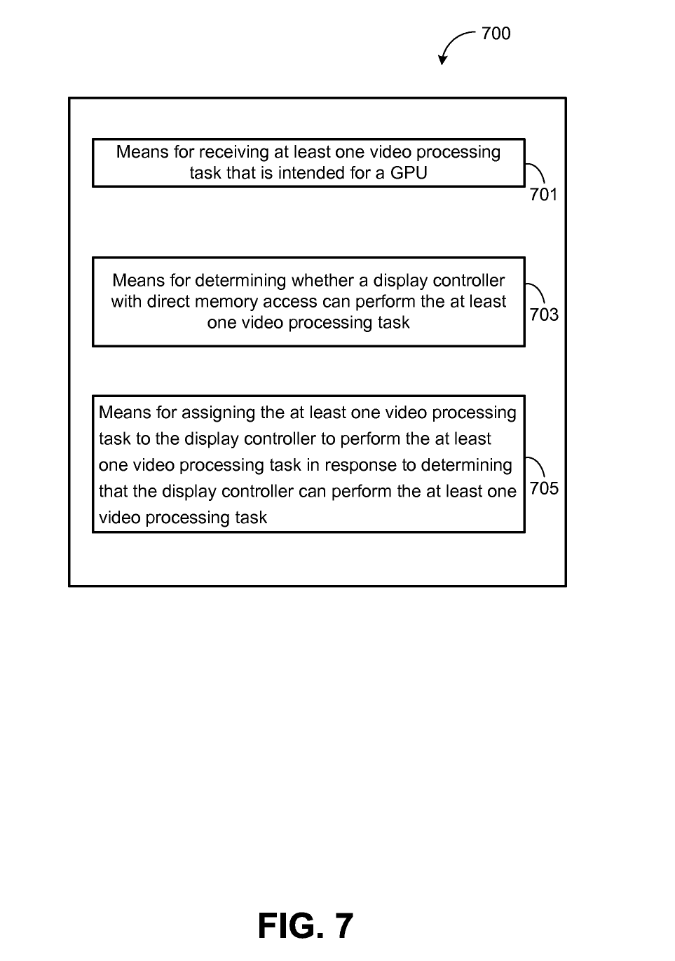

The method 600 described in FIG. 6A above may be performed by various hardware and/or software component(s) and/or module(s) corresponding to the means-plus-function blocks of apparatus 700 illustrated in FIG. 7. In other words, blocks 601-605 illustrated in FIG. 6A correspond to means-plus-function blocks 701-705 illustrated in FIG. 7. In particular embodiments, the apparatus 700 may correspond to the chipset 120 or component thereof. In further embodiments, the task controller 125 may be configured for receiving at least one video processing task that is intended for a GPU (e.g., 122) (701), determining whether a display controller (e.g., 123) with direct memory access can perform the at least one video processing task (703), and/or assigning the at least one video processing task to the display controller to perform the at least one video processing task in response to determining that the display controller can perform the at least one video processing task (705). In other embodiments, one or more other components (e.g., the GPU 122 and/or the display controller 123) may be configured to perform one or more of the means-plus-function blocks 701-705.

FIG. 6B is a flowchart of a method 650 for accelerating video post processing according to various embodiments of the disclosure. With reference to FIGS. 1-6B, at block 651, the method 650 may perform post processing of video content on a mobile device having a mobile station modem (e.g., chipset 120) comprising a graphics processing unit (GPU) (e.g., 122) and a display controller processor (e.g., 123). Next at block 653, the method 650 determines whether a type of a video post processing task is a first type or a second type. Next at block 655, the video post processing task may be performed by the display controller 123 if the task is determined to be the first type. Next at block 657, the video post processing task may be performed on the GPU 122 if the task is determined to be the second type. In particular embodiments, the first and the second type of task may be determined based on (but not limited to) the list of tasks that are enumerated in Table 1 above.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for performing video processing on a mobile device, the method comprising:
receiving at least one video processing task that is intended for a graphic processing unit (GPU);
determining whether a display controller with direct memory access can perform the at least one video processing task; and
assigning the at least one video processing task to the display controller to perform the at least one video processing task in response to determining that the display controller can perform the at least one video processing task.

2. The method of claim 1, further comprising:
processing, by the display controller, video by performing the at least one video processing task; and
outputting, by the display controller, the processed video directly to a display device without storing the result of the video processing in a memory.

3. The method of claim 1, further comprising:
processing, by the GPU, video by performing the at least one video processing task in response to determining that the display controller cannot perform the at least one video processing task.

4. The method of claim 3, further comprising:
storing, by the GPU, a result of processing the video in a graphic memory while performing the at least one video processing task; and
outputting, from the memory, the result to a display device.

5. The method of claim 1, wherein the determining comprises determining whether the display controller is capable of performing the at least one video processing task.

6. The method of claim 1, wherein the determining comprises determining whether the display controller performs the at least one video processing task faster than the GPU would performing the at least one video processing task.

7. The method of claim 1, wherein the determining comprises determining whether the display controller performs the at least one video processing task using less power than the GPU would performing the at least one video processing task.

8. The method of claim 1, wherein the determining comprises determining whether the display controller has a processing bandwidth to perform the at least one video processing task within a predetermined time period.

9. The method of claim 1, wherein the determining comprises determining whether the display controller is available to perform the at least one video processing task.

10. The method of claim 1,
wherein the determining comprises determining whether the at least one video processing task is one of a first processing task type or a second processing task type;
wherein the display controller can perform the at least one video processing task if the at least one processing task is of the first processing task type; and wherein the display controller cannot perform the at least one video processing task if the at least one processing task is of the second processing task type.

11. The method of claim 1, wherein the at least one video processing task is at least one of blending, scaling, de-interlacing, color conversion of video.

12. The method of claim 1, wherein the GPU is distinct from the display controller.

13. The method of claim 1, wherein the GPU and the display controller are integrated on a system on chip.

14. The method of claim 1, wherein the display controller further comprises:
a video processing module that outputs a video data stream that is sent to a layer mixer determination module;
a primary display module that outputs a video data stream that is sent to the layer mixer determination module; and
a secondary display module that outputs a video data stream that is sent to the layer mixer determination module;
wherein the layer determination module is configured to select at least one layer mixer from a plurality of layer mixers to perform blending for the at least one of the video processing module, the primary display module, and the secondary display module.

15. The method of claim 1,
wherein the GPU comprises a 3D engine; and
wherein the display controller comprises a 2D engine.

16. The method of claim 1, wherein the display controller is configured to use direct memory access (DMA) to process at least one video processing task in real time and output the result to the display device.

17. A system for performing video processing on a mobile device, the system comprising:
a graphic processing unit (GPU);
a display controller having direct memory access, the display controller configured to perform at least one video process task intended for the GPU; and
a task controller configured to determine whether the display controller can perform the at least one video processing task;
the task controller configured to assign the at least one video processing task to the display controller in response to determining that the display controller can perform the at least one video processing task.

18. The system of claim 17,
wherein the display controller is configured to process video by performing the at least one video processing task; and
wherein the display controller is configured to output the processed video directly to a display device without storing the result of the video processing in a memory.

19. An apparatus for performing video processing on a mobile device, the apparatus comprising:
means for receiving at least one video processing task that is intended for a graphic processing unit (GPU);
means for determining whether a display controller with direct memory access can perform the at least one video processing task; and
means for assigning the at least one video processing task to the display controller to perform the at least one video processing task in response to determining that the display controller can perform the at least one video processing task.

20. The apparatus of claim 19, comprising:
means for processing, by the display controller, video by performing the at least one video processing task; and
means for outputting, by the display controller, the processed video directly to a display device without storing the result of the video processing in a memory.
